(19) United States
(12) Patent Application Publication
(10) Pub. No.: US 2026/0054776 A1
(43) Pub. Date: Feb. 26, 2026

(54) VEHICLE FRONT STRUCTURE

(71) Applicant: TOYOTA JIDOSHA KABUSHIKI KAISHA, Toyota-shi (JP)

(72) Inventor: Toshiaki SATO, Nagakute-shi (JP)

(73) Assignee: TOYOTA JIDOSHA KABUSHIKI KAISHA, Toyota-shi (JP)

(21) Appl. No.: 19/097,986

(22) Filed: Apr. 2, 2025

(30) Foreign Application Priority Data
Aug. 26, 2024 (JP) 2024-144301

(51) Int. Cl. B62D 21/15

(52) U.S. Cl. CPC B62D 21/155

(57) ABSTRACT

A bumper reinforcement is disposed forward of a front module. The front module includes a front side member. An outer end of the bumper reinforcement in a vehicle width direction is disposed outward of the front side member in the vehicle width direction. The front side member is in the shape of a rectangular groove that is open outward in the vehicle width direction. A horizontal rib and vertical ribs are formed in the rectangular groove of the front side member. A reinforcing piece (load transfer member) is disposed in the grid of the horizontal and vertical ribs.

### CROSS-REFERENCE TO RELATED APPLICATION

This application claims priority to Japanese Patent Application No. 2024-144301 filed on Aug. 26, 2024. The disclosure of the above-identified application, including the specification, drawings, and claims, is incorporated by reference herein in its entirety.

### BACKGROUND

### 1. Technical Field

The present specification discloses a vehicle front structure.

### 2. Description of Related Art

A bumper reinforcement is provided as a framework member at the front of a vehicle. The bumper reinforcement extends in a vehicle width direction. The bumper reinforcement is connected to front side members.

The front side members are framework members extending in a vehicle front-rear direction. Front ends of the front side members are coupled to the back of the bumper reinforcement. Outer ends of the bumper reinforcement in the vehicle width direction are located outward of these coupling points in the vehicle width direction.

A small overlap test is known as a type of vehicle crash test. In the small overlap test, the offset is set to 25%. That is, the overlap between a vehicle and a barrier is set to 25% of the vehicle width dimension.

In the small overlap test, an outer portion of the bumper reinforcement in the vehicle width direction impacts the barrier. Due to the impact, the outer portion of the bumper reinforcement in the vehicle width direction is buckled toward the rear of the vehicle. For example, in Japanese Unexamined Patent Application Publication No. 2020-183191 (JP 2020-183191 A), load transfer members are provided at the outer ends of a bumper reinforcement in the vehicle width direction. The load transfer members extend from the back of the bumper reinforcement toward the rear of a vehicle. When the bumper reinforcement buckles toward the rear of the vehicle and inward in the vehicle width direction, the load transfer member impacts the front side member. This reduces bending deformation of the bumper reinforcement and stops intrusion of a barrier.

Fender aprons are also attached to the front side members. For example, in Japanese Unexamined Patent Application Publication No. 2021-17100 (JP 2021-17100 A), fender aprons are fixed to front side members via apron gussets. Each apron gusset is disposed on a trajectory along which a corresponding load transfer member on a bumper reinforcement intrudes in the event of a small overlap crash. Each apron gusset is provided with a reinforcing member.

### SUMMARY

A framework portion and a panel portion of the front part of a vehicle are sometimes formed integrally by casting. Such a single-piece cast product is also called a front module. When the thickness of the front module varies greatly depending on the location, cracking or distortion occurs due to the difference in the manner in which shrinkage occurs during a cooling process. Therefore, a reinforcing rib is formed in a framework component instead of increasing the thickness of the framework component. For example, a rib extending in the vehicle width direction is provided on each front side member.

A load transfer member of a bumper reinforcement may impact the rib of the front side member in the event of a small overlap crash. If the rib breaks due to the impact, it may be difficult to stop bending deformation of the bumper reinforcement.

Therefore, the present specification discloses a vehicle front structure that can reduce progression of bending deformation of a bumper reinforcement in the event of a small overlap crash.

The present specification discloses a vehicle front structure. The vehicle front structure includes a front module, a bumper reinforcement, and an extension member. The front module is a single-piece cast component including a framework portion and a panel portion that are located in a front region of a vehicle. The bumper reinforcement is disposed forward of the front module. The bumper reinforcement extends in a vehicle width direction. The extension member extends from an outer end of the bumper reinforcement in the vehicle width direction toward the rear of the vehicle. The front module includes a front side member. The front side member extends in a vehicle front-rear direction. A front end of the front side member is coupled to the bumper reinforcement. The outer end of the bumper reinforcement in the vehicle width direction is located outward of the front side member in the vehicle width direction. The front side member is in the shape of a rectangular groove that is open outward in the vehicle width direction. A rib is provided in the rectangular groove of the front side member. The rib is provided in a grid pattern. The rib also extends outward in the vehicle width direction. A load transfer member is disposed in a grid of the rib.

With the above configuration, the load transfer member can receive impact from the extension member.

In the above configuration, the load transfer member may protrude outward in the vehicle width direction beyond the rib.

The above configuration can reduce cracking of the rib.

In the above configuration, a cross member may be connected to the front module.

The cross member extends in the vehicle width direction.

The load transfer member may be disposed on an extension line of the cross member.

With the above configuration, an impact load is transferred from the extension member to the cross member via the load transfer member.

In the above configuration, the load transfer member may be a collection of the ribs. In this case, the ribs of the collection are provided at a higher density than in the surrounding region.

Since the ribs are provided at a high density, broken pieces of the ribs fill the grid when the ribs break. This reduces intrusion of the extension member.

The vehicle front structure disclosed in the present specification can reduce progression of bending deformation of the bumper reinforcement in the event of a small overlap crash.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded perspective view illustrating a vehicle structure;

FIG. 2 is a perspective view illustrating the front module and its peripheral members;

FIG. 3 is a partial cross-sectional perspective view of FIG. 2; and

FIG. 4 is a perspective view illustrating a front module according to a first modification.

### DETAILED DESCRIPTION OF EMBODIMENTS

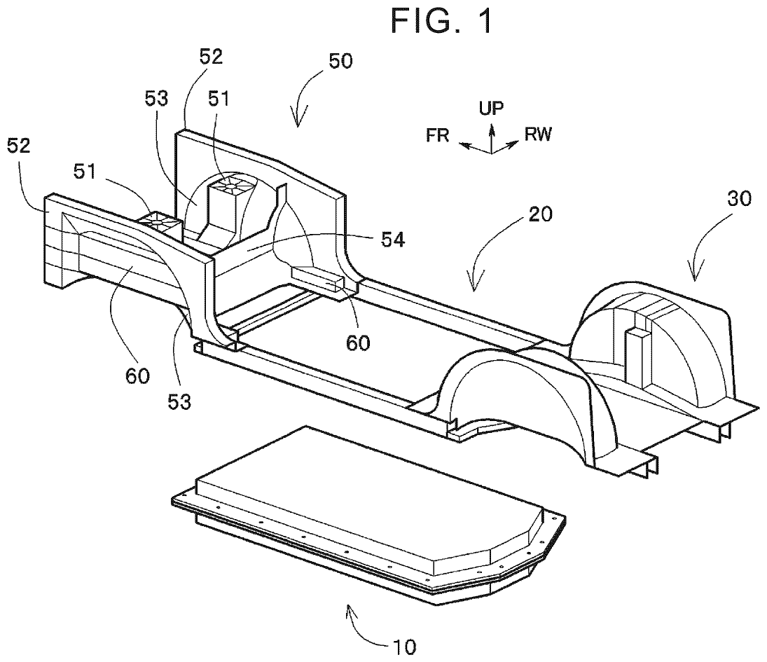

FIGS. 1 to 4 illustrate a vehicle front structure according to the present embodiment. The vehicle front structure according to the present embodiment is mounted on a battery electric vehicle (BEV).

In FIGS. 1 to 4, the vehicle front-rear direction is shown by an FR-axis. The vehicle width direction is shown by an RW-axis. The vertical direction is shown by an UP-axis. The positive direction of the FR-axis is a forward direction. The positive direction of the RW-axis is a rightward direction. The positive direction of the UP-axis is a height direction.

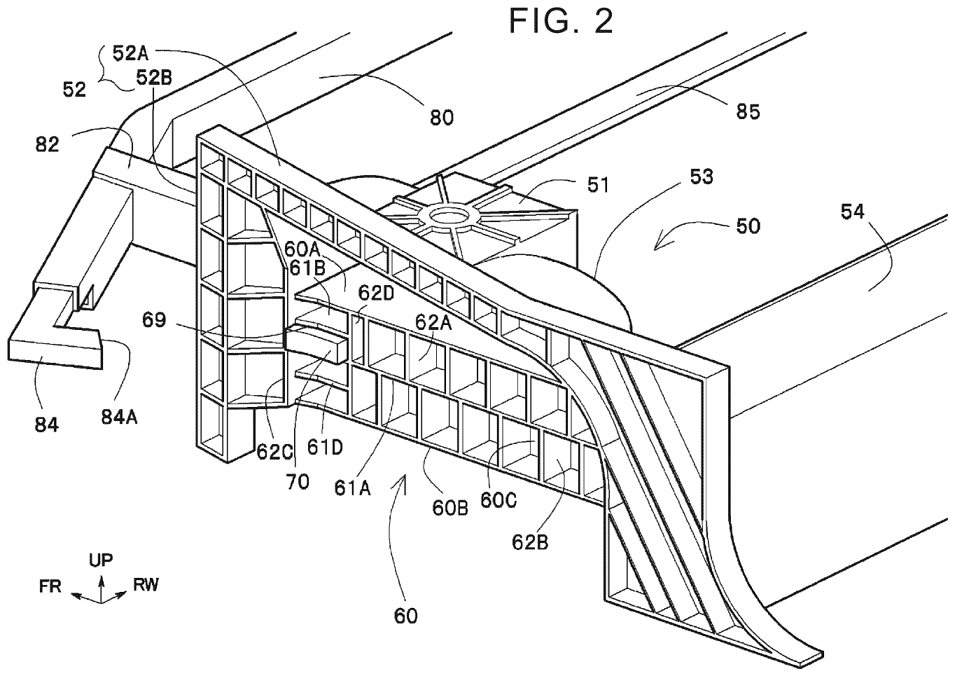

FIGS. 2 to 4 illustrate the structure of the left portion of the vehicle. However, based on the symmetrical structure of the vehicle body, the structure of the right portion of the vehicle also corresponds to FIGS. 2 to 4.

### 1. Vehicle Structure

FIG. 1 is an exploded perspective view of a framework structure of a vehicle and a battery pack 10. The framework structure includes a front module 50, a frame 20, and a rear module 30.

The frame 20 is a framework member in the form of a frame. The frame 20 supports the battery pack 10.

The front module 50 is a single-piece cast product obtained by integrally casting a framework portion and a panel portion that are located in a front region of the vehicle. Details of the front module 50 will be described later. The rear module 30 is a single-piece cast product obtained by integrally casting a framework portion and a panel portion that are located in a vehicle rear region.

### 2. Framework Components Connected to Front Module

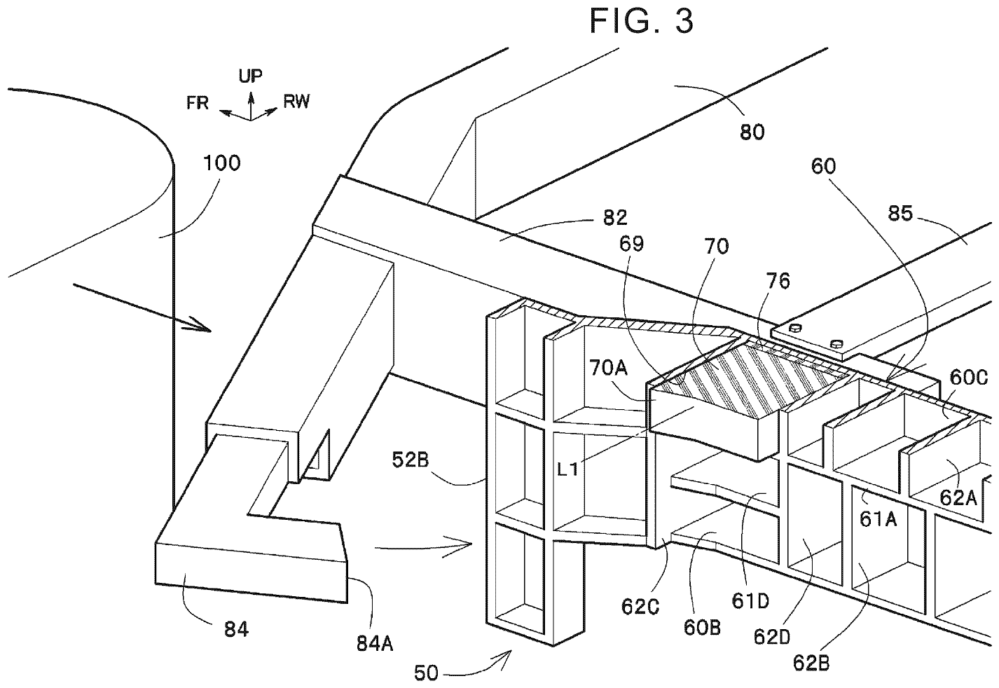

A plurality of framework components is connected to the front module 50. Referring to FIGS. 2 and 3, a bumper reinforcement 80, a connecting member 82, and a front cross member 85 are connected to the front module 50.

Referring to FIG. 3, the connecting member 82 is an extended portion of the front side member 60. The connecting member 82 is coupled to the front ends of the pair of front side members 60, 60. The connecting member 82 is, for example, a hollow member having a rectangular cross section. The front end of the connecting member 82 is connected to the rear surface of the bumper reinforcement 80. That is, the front end of the front side member 60 is coupled to the bumper reinforcement 80 via the connecting member 82.

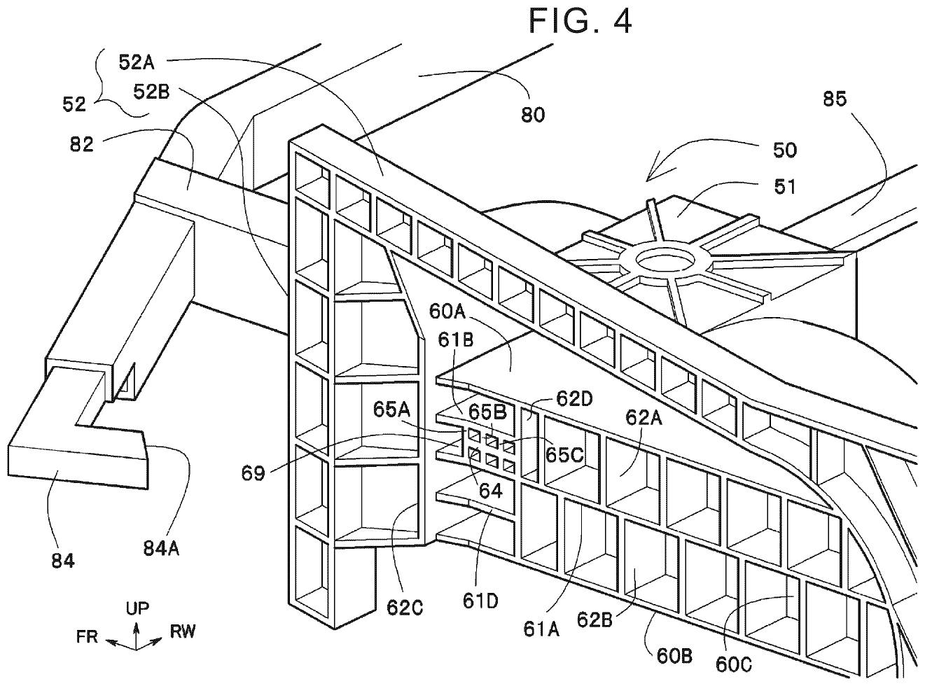

The front cross member 85 extends linearly along the vehicle width direction. The front cross member 85 extends from one connecting member 82 to the other connecting member 82. The reinforcing piece 70 is disposed on an extension line L1 (see FIG. 3) of the front cross member 85. Alternatively, vertical ribs 65A to 65C (see FIG. 4) and a horizontal rib 64 are arranged on the extension line L1 of the front cross member 85.

For example, referring to FIG. 3, the reinforcing piece 70 is adjacent, in the vehicle width direction, to the outer end of the front cross member 85 in the vehicle width direction with the front side member 60 interposed therebetween. Referring to FIG. 4, the vertical ribs 65A to 65C and the horizontal rib 64 are adjacent, in the vehicle width direction, to the outer end of the front cross member 85 in the vehicle width direction with the front side member 60 interposed therebetween.

As will be described later, an impact load is transferred from the reinforcing piece 70 (see FIG. 3) to the front cross member 85. Alternatively, the impact load is transferred from the vertical ribs 65A to 65C (see FIG. 4) and the horizontal rib 64 to the front cross member 85.

The bumper reinforcement 80 is a framework component disposed on the front surface of the vehicle. The bumper reinforcement 80 is disposed forward of the front module 50. Referring to FIG. 3, the bumper reinforcement 80 is connected to the front side member 60 via the connecting member 82. An outer end of the bumper reinforcement 80 in the vehicle width direction is disposed outward of the front side member 60 in the vehicle width direction.

The bumper reinforcement 80 extends in the vehicle width direction. For example, both ends of the bumper reinforcement 80 in the vehicle width direction are tilted toward the rear of the vehicle so as to conform to the design of the front surface of the vehicle.

An extension 84 is provided at an outer end of the bumper reinforcement 80 in the vehicle width direction. For example, extensions 84 are provided at both ends of the bumper reinforcement 80 in the vehicle width direction. The extension 84 is an extension member added to the bumper reinforcement 80. The extension 84 has, for example, an L-shape as viewed in plan.

The extension 84 extends from the outer end of the bumper reinforcement 80 in the vehicle width direction toward the rear of the vehicle. For example, the extension 84 extends outward in the vehicle width direction from both ends of the bumper reinforcement 80 in the vehicle width direction. Further, the extension 84 extends toward the rear of the vehicle.

Referring to FIG. 3, the barrier 100 impacts the bumper reinforcement 80 in the event of a small overlap crash. Due to the impact, the outer portion of the bumper reinforcement 80 in the vehicle width direction is bent and deformed. In this bending deformation, the outer portion of the bumper reinforcement 80 in the vehicle width direction is bent inward in the vehicle width direction and toward the rear of the vehicle.

With this bending deformation, the extension 84 is also displaced inward in the vehicle width direction and toward the rear of the vehicle. The rear end 84A of the extension 84 impacts the front side member 60. As will be described below, the rear end 84A of the extension 84 impacts the reinforcing piece 70. As a result, the progression of bending deformation of the bumper reinforcement 80 is reduced.

### 3. Front Module

Referring to FIG. 1, the front module 50 is a single-piece cast product obtained by integrally casting the framework portion and the panel portion that are located between the right and left front wheels of the vehicle. For example, the front module 50 is manufactured by aluminum die casting.

The front module 50 includes a dash panel 54 and a pair of front wheelhouses 53, 53 as panel portions. The front module 50 includes a pair of suspension towers 51, 51, a pair of radiator supports 52, 52, and a pair of front side members 60, 60 as framework portions.

For example, as illustrated in FIG. 2, ribs for reinforcement are formed in the framework portion. For example, the radiator support 52 includes an upper support 52A and a side support 52B. A plurality of ribs extending outward in the vehicle width direction is formed in the upper support 52A and the side support 52B.

### 4. Front Side Member

Referring to FIG. 2, the front side member 60 is a framework portion extending in the vehicle front-rear direction. The front side member 60 is in the shape of a rectangular groove that is open outward in the vehicle width direction. That is, the front side member 60 includes an upper wall 60A, a lower wall 60B, and a side wall 60C. The upper wall 60A and the lower wall 60B extend in the vehicle width direction. The inner ends of the upper wall 60A and the lower wall 60B in the vehicle width direction are connected to the side wall 60C. The side wall 60C extends in the height direction.

The plurality of ribs is formed in a rectangular groove formed by an upper wall 60A, a lower wall 60B, and a side wall 60C. The plurality of ribs is formed in a grid pattern in the rectangular groove. The ribs extend outward in the vehicle width direction from the side wall 60C. For example, the front side member 60 is provided with a horizontal rib 61A and a vertical rib 62B.

The horizontal rib 61A is disposed between the upper wall 60A and the lower wall 60B. The horizontal rib 61A divides the front side member 60 into two rooms, namely upper and lower rooms. A vertical rib 62A is disposed in the upper room. The vertical rib 62B is disposed in the lower room. A plurality of the vertical ribs 62A and a plurality of the vertical ribs 62B are provided at intervals in the vehicle front-rear direction. The verticals rib 62A and the vertical ribs 62B are arranged offset in the vehicle front-rear direction.

Vertical ribs 62C, 62D, the horizontal ribs 61A, 61B, 61D, and the lower wall 60B divide the front end portion of the front side member 60 into a grid pattern. A reinforcing piece 70 is disposed in the grid. For example, the reinforcing piece 70 is accommodated in the slot 69 having the same height as the extension 84.

The reinforcing piece 70 is a load transfer member. For example, the reinforcing piece 70 is a solid component. For example, the reinforcing piece 70 is a resin component containing glass fiber.

FIG. 3 illustrates a cross-sectional perspective view of the front module 50 cut at the same height as the upper wall of the connecting member 82. An adhesive 76 is applied to the bottom of the slot 69, in other words to the side wall 60C. The reinforcing piece 70 is inserted into the slot 69. The adhesive 76 secures the reinforcing piece 70 in the slot 69.

The shape of the reinforcing piece 70 may conform to the slot 69. That is, the reinforcing piece 70 is formed to be equal to the opening width and the opening height of the slot 69.

On the other hand, the reinforcing piece 70 may protrude outward in the vehicle width direction beyond the vertical ribs 62C, 62D and the horizontal ribs 61A, 61B. For example, an outer end 70A of the reinforcing piece 70 in the vehicle width direction is disposed outward of the vertical ribs 62C, 62D and the horizontal ribs 61A, 61B in the vehicle width direction. With such a structure, the extension 84 can be received exclusively by the reinforcing piece 70.

For example, in the case where the front module 50 is an aluminum cast product, cracking of the ribs tends to occur as compared to other steel materials. A variant of aluminum is called local elongation (point elongation). That is, unlike the uniform elongation in which the deformation start point and its surrounding portion are uniformly deformed, the load concentrates on the input point of the load. Therefore, there is a possibility that a crack may occur in a portion subjected to a load.

In place of the vertical ribs 62C, 62D and the horizontal ribs 61A, 61B, the reinforcing piece 70 receives the extension 84. This reduces cracking of these ribs. The reinforcing piece 70 receives the extension 84. This stops the bending deformation of the bumper reinforcement 80. That is, the barrier 100 is less likely to slip out of the bumper reinforcement 80.

The reinforcing piece 70 is disposed on the extension line L1 (see FIG. 3) of the front cross member 85. Therefore, the load applied from the extension 84 to the reinforcing piece 70 is transferred to the front cross member 85.

### 5. First Modification of Front Side Member

FIG. 4 illustrates the front side member 60 according to a first modification. In this example, ribs that substitute for the reinforcing piece 70 are formed in the slot 69. In other words, a grid structure is formed in the slot 69 by the vertical ribs 65A, 65B, 65C and the horizontal rib 64. The grid structure formed by the vertical ribs 65A, 65B, 65C and the horizontal rib 64 forms a collection of ribs that are formed at a higher density than in the surrounding region.

When the extension 84 is received by the vertical ribs 65A, 65B, 65C and the horizontal rib 64, these ribs break. Broken pieces of the ribs fill the slot 69. That is, the broken pieces of the ribs filling the slot 69 stop intrusion of the extension 84.

The vertical ribs 65A, 65B, 65C and the horizontal rib 64 are arranged on the extension line of the front cross member 85. Therefore, the load applied from the extension 84 to the vertical ribs 65A, 65B, 65C and the horizontal rib 64 is transferred to the front cross member 85.

What is claimed is:

1. A vehicle front structure comprising:
a front module that is a single-piece cast component including a framework portion and a panel portion that are located in a front region of a vehicle;
a bumper reinforcement disposed forward of the front module and extending in a vehicle width direction; and
an extension member extending from an outer end of the bumper reinforcement in the vehicle width direction toward a rear of the vehicle, wherein:
the front module includes a front side member;
the front side member extends in a vehicle front-rear direction, and a front end of the front side member is coupled to the bumper reinforcement;
the outer end of the bumper reinforcement in the vehicle width direction is located outward of the front side member in the vehicle width direction;
the front side member is in a shape of a rectangular groove that is open outward in the vehicle width direction;
a rib extending outward in the vehicle width direction is provided in a grid pattern in the rectangular groove of the front side member; and
a load transfer member is disposed in a grid of the rib.

2. The vehicle front structure according to claim 1, wherein the load transfer member protrudes outward in the vehicle width direction beyond the rib.

3. The vehicle front structure according to claim 1, wherein:
a cross member extending in the vehicle width direction is connected to the front module; and
the load transfer member is disposed on an extension line of the cross member.

4. The vehicle front structure according to claim 3, wherein the load transfer member is a collection of the ribs provided at a higher density than in a surrounding region.
